(19) United States
(12) Patent Application Publication
(10) Pub. No.: US 2019/0071333 A1
(43) Pub. Date: Mar. 7, 2019

(54) COMPOSITIONS AND METHOD FOR PROVIDING POTABLE WATER SUBSTANTIALLY FREE OF TRIHALOMETHANES

(71) Applicant: Gary M Palecek, Norman, OK (US)

(72) Inventor: Gary M Palecek, Norman, OK (US)

(21) Appl. No.: 15/645,662

(22) Filed: Sep. 5, 2017

(51) Int. Cl. C02F 1/68

(52) U.S. Cl. CPC C02F 1/68; C02F 2101/36

(57) ABSTRACT

The trihalomethane treatment compositions are comprised of a mineral acid, a glycol, ether, and an alkanolamine. The treatment methods entail determining the level of THM within the water and injecting or adding a sufficient quantity of the THM treatment composition into the contaminated water under ambient conditions to lower or maintain the ppb of THM to a safe level.

### BACKGROUND

Trihalomethanes (THM) occur within water treatment systems when naturally occurring organic compounds react with water treatment agents such as disinfectant, chlorine and chloramine. According to information published by the United States Environmental Protection Agency (EPA), the concentration of all trihalomethanes in drinking water should be less than 80 parts per billion (ppb). The EPA further notes that drinking of water containing trihalomethanes in excess of the maximum contamination level over many years could experience increased risk of cancer as well as liver, kidney or central nervous system problem.

Clearly removal of or preventing the formation of THM within municipal water supplies is desirable. Preferably, the compositions and methods used to remove THM will provide potable water with THM concentration well below 80 ppb. Further, the compositions and methods must also be safe for consumption. The present invention provides a composition suitable for removing or precluding the formation of THM from water. In many cases, use of the present invention provides potable water with no detectible levels of THM.

### BRIEF SUMMARY

In one embodiment, the present invention is an aqueous composition comprising a mineral acid, a glycol ether and an alkanolamine.

In another embodiment, the present invention is an aqueous composition comprising a mineral acid, an alkanolamine, and a glycol ether. The mineral acid is selected from the group consisting of phosphoric acid, hydrochloric acid, nitric acid, sulfuric acid and mixtures thereof. The alkanolamine is selected from the group consisting of ethanolamine, diethanolamine, triethanolamine and mixtures thereof. The glycol ether is selected from the group consisting of propylene glycol mono-methyl ether, dipropylene glycol methyl ether, dipropylene glycol, ethylene glycol monobutyl ether, diethylene glycol monopropylene ether, propylene glycol t-butyl ether, and mixtures thereof. The mineral acid comprises from about 10% to about 50% by weight of the final composition. The glycol ether comprises from about 0.005% to about 25% by weight of the composition. The alkanolamine comprises from about 0.003% to about 10% by weight of the composition.

Additionally, the present invention provides a method for preparing a composition suitable for reducing the trihalomethane concentration within water. The method of the present invention initially prepares a solution of mineral acid in water wherein the mineral acid comprises from about 20% to about 60% by weight of the aqueous solution. Subsequently, the method calls for the addition of an alkanolamine to the aqueous acid solution. Finally, a glycol ether is added to the solution containing the alkanolamine and mineral acid.

Still further, the present invention provides a method for preparing a composition suitable for removing trihalomethane or at least reducing the concentration of trihalomethane in water. The method of the present invention initially prepares a solution of mineral acid in water wherein the mineral acid comprises from about 20% to about 60% by weight of the aqueous solution. Subsequently, the method calls for the addition of an alkanolamine to the aqueous acid solution. Finally, a glycol ether is added to the solution containing the alkanolamine and mineral acid. In the final composition, the mineral acid comprises from about 5% to about 50% by weight of the final solution; the alkanolamine comprises from about 0.003% to about 10% of the final solution; and, the glycol ether comprises from about 0.005% to about 25% of the final solution. Compounds suitable for each of the identified components are identified in the preceding paragraphs.

Still further, the present invention provides methods for treating water contaminated with THM. The method of the current invention includes the steps of preparing a THM treatment composition comprising comprising a mineral acid, an alkanolamine, and a glycol ether. The mineral acid is selected from the group consisting of phosphoric acid, hydrochloric acid, nitric acid, sulfuric acid and mixtures thereof. The alkanolamine is selected from the group consisting of ethanolamine, diethanolamine, triethanolamine and mixtures thereof. The glycol ether is selected from the group consisting of propylene glycol mono-methyl ether, dipropylene glycol methyl ether, dipropylene glycol, ethylene glycol monobutyl ether, diethylene glycol monopropylene ether, propylene glycol t-butyl ether, and mixtures thereof. The mineral acid comprises from about 10% to about 50% by weight of the final composition. The glycol ether comprises from about 0.005% to about 25% by weight of the composition. The alkanolamine comprises from about 0.003% to about 10% by weight of the composition. Following preparation of the THM treatment composition, the THM treatment composition is added to a water treatment system at one of several optional injection points within the treatment system and/or at locations within the water distribution system delivering water to customers. The THM treatment composition is injected at a rate of about 0.05 to about 0.1 milliliters of aqueous THM treatment composition will be injected per liter of treated water.

### BRIEF DESCRIPTION OF THE DRAWINGS

FIG. 1 schematically depicts the injection points for the application of the trihalomethane reducing compound within a municipal water treatment system

FIG. 2 depicts the test results for treatment of water containing trihalomethane.

### DETAILED DESCRIPTION

The composition of the present invention is particularly suitable for reducing or elimination trihalomethane from municipal water supplies. In addition, the present invention will be applicable to other water treatment processes designed to provide potable water.

As disclosed herein, the aqueous THM treatment composition comprises a mineral acid, an alkanolamine and a glycol ether. Suitable mineral acids include: phosphoric acid, hydrochloric acid, nitric acid and sulfuric acid and mixtures thereof. Suitable glycol ethers include, but are not limited to: propylene glycol mono-methyl ether, dipropylene glycol methyl ether, dipropylene glycol, ethylene glycol monobutyl ether, diethylene glycol monopropyl ether, propylene glycol t-butyl ether, diethylene glycol ethyl ether, ethylene glycol monomethyl ether, ethylene glycol monoethyl ether, ethylene glycol monopropyl ether, ethylene glycol monoisopropyl ether, diethylene glycol monomethyl ether, ethylene glycol dimethyl ether, ethylene glycol diethyl ether, ethylene glycol dibutyl ether ethylene glycol methyl ether acetate, ethylene glycol monethyl ether acetate, ethylene glycol monobutyl ether acetate and mixtures thereof. Suitable alkanoiamines include, but are not limited to: ethanolamine, diethanolamine, triethanolamine and mixtures thereof. As will be discussed below, currently the composition most effective at reducing the concentration of trihalomethane comprises phosphoric acid, triethanolamine and dipropylene glycol methyl ether.

In the aqueous THM treatment composition, the mineral acid comprises from about 10% to about 50% by weight of the composition; the alkanolamine comprises from about 0.003% to about 10% by weight of the composition; and, the glycol ether comprises from about 0.004% to about 25% by weight of the composition and water comprises the remainder of the composition. More typically, the mineral acid comprises from about 20% to about 45% by weight of the composition; the alkanolamine comprises from about 0.005% to about 10% by weight of the composition; and, the glycol ether comprises from about 0.005% to about 21% by weight of the composition and water comprises the remainder of the composition. However, generally, the mineral acid comprises from about 24% to about 35% by weight of the composition; the alkanolamine comprises from about 0.005% to about 10% by weight of the composition; and, the glycol ether comprises from about 0.005% to about 10% by weight of the composition and water comprises the remainder of the composition. The final percent by weight of each component may be adjusted based on initial tests of the water to be treated. However, in general when using phosphoric acid, the most preferred concentration of mineral acid will be about 25% by weight, when using triethanolaminethe most preferred concentration of alkanolamine will be about 0.01% by weight, when using dipropylene glycol monomethyl ether as the glycol ether, the most preferred concentration will be about 0.5% by weight and water comprises the remainder of the composition. For the purposes of clarity, the ranges recited above are intended to all concentrations between the outer limits. Thus, for example a range between 1 and 5 reflects, without recitation, the range 1, 2, 3, 4 and 5 as if each number were recited.

In addition to the indicated components, the composition of the present invention may also include corrosion inhibitors, such as but not limited to formulations based on ethoxylated amines, sodium (bi)sulfate, or ortho- or polyphosphates. When included, the corrosion inhibitors will normally comprise from about 0.1% to about 2% by weight of the THM treatment composition. Other additives suitable for incorporation into the composition include but are not limited to: sequestering agents, such as oligo- or polyphoshates.

The present invention includes a method for preparing the above-described aqueous THM treatment composition. The method of the present invention initially prepares an aqueous solution of mineral acid comprising from about 20% to about 60% by weight of mineral acid in water. The resulting aqueous acid solution is mixed or blended for a time period sufficient to ensure complete dissolution of the acid in the water. Typically, mixing continues for about 5 minutes to about 60 minutes. More typical mixing times may range from about 10 minutes to 50 minutes. Preferably, the mixing time is from about 15 minutes to 45 minutes and more preferably the mixing time is for only about 15 minutes to about 40 minutes. Mixing times will vary with the size of the composition being prepared.

As noted above, suitable mineral acids include phosphoric acid, hydrochloric acid, nitric acid and sulfuric acid and mixtures thereof.

Following preparation of the aqueous acid solution, the alkanolamine is added to the aqueous acid solution. The resulting solution is mixed or blended for a time period sufficient to ensure complete dissolution of the alkanolamine. Typical mixing times may run from about 5 minutes to about 60 minutes. More typical mixing times may range from about 10 minutes to 50 minutes. Preferably, the mixing time is from about 15 minutes to 45 minutes and more preferably the mixing time is for only about 15 minutes to about 35 minutes. Mixing times will vary with the size of the composition being prepared.

As noted above, suitable alkanolamines include, but are not limited to: ethanolamine, diethanolamine, triethanolamine and mixtures thereof.

Finally, the glycol ether is added to the aqueous solution. The final solution is mixed or blended for a time period sufficient to ensure complete dissolution of the glycol ether into the solution thereby providing the composition suitable for reducing trihalomethane. Typical mixing times may run from about 5 minutes to about 90 minutes. Depending on the volume of the solution, mixing times may range from about 10 minutes to about 80 minutes. Alternatively, mixing times may range from about 15 minutes to 75 minutes. Generally, mixing times may range from about 20 minutes to 70 minutes. More typical mixing times may range from about 25 minutes to 70 minutes. Preferably, the mixing time is from about 30 minutes to 70 minutes and more preferably the mixing time is for only about 35 minutes to about 60 minutes.

As noted above, suitable glycol ethers include, but are not limited to: propylene glycol mono-methyl ether, dipropylene glycol methyl ether, dipropylene glycol, ethylene glycol monobutyl ether, diethylene glycol monopropylene ether, propylene glycol t-butyl ether, and mixtures thereof.

The final concentrations by weight of mineral acid, alkanolamine and glycol ether in the resulting solution correspond to the previously discussed values.

As noted above, the composition of the present invention may also include corrosion inhibitors, such as but not limited to formulations based on ethoxylated amines, sodium (bi)sulfate, or ortho- or polyphosphates. The corrosion inhibitor and other additives such as ortho- or polyphosphate sequestration agents, will be added to the composition of the present invention following the addition of the glycol ether. However, the inclusion of any such additives will be made in a manner such that the percent by weight of the mineral acid, alkanolamine and glycol ether in the resulting solution satisfies the values described above.

The present invention also provides a method for reducing or eliminating trihalomethane from water supplies thereby providing potable water. The method of the present invention is particularly suitable for use in municipal water treatment system. As known to those skilled in the art, municipal water treatment systems commonly use chlorine as a disinfecting agent. Unfortunately, the chlorine tends to react with organic compounds within water to produce trihalomethane. Safe levels of trihalomethane in potable water are determined by government authorities. Current levels in the United States are set at 80 parts per billion (ppb).

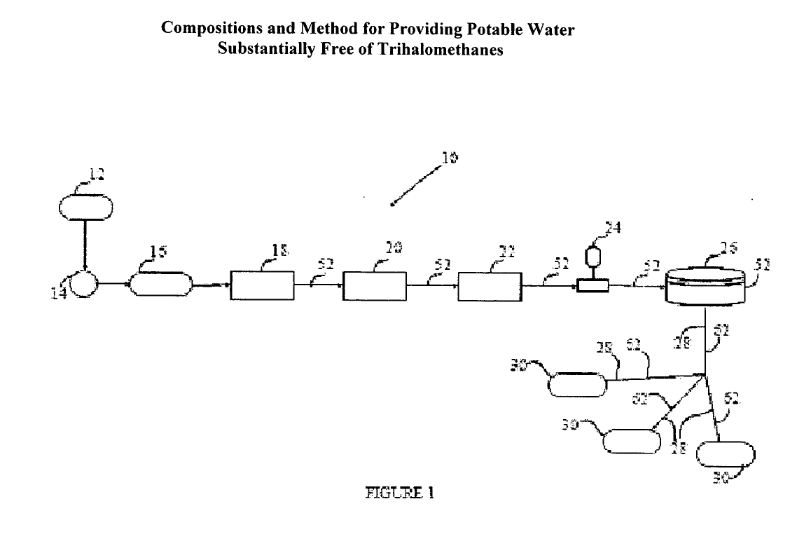

FIG. 1 depicts components commonly found in a municipal water treatment system and a portion of the water distribution system. As known to those skilled in the art, municipal water system 10 commonly includes: a water source such as a reservoir 12, a raw water tank 16, a coagulation tank 18 for removing sediment and clarifying the water; a flocculation and clarification system 20, a filtration system 22, a disinfection system 24, a one or several storage tanks 26 and supply lines 28 providing water to municipal customers 30. Those skilled in the art will recognize that FIG. 1 represents a generic municipal water supply system and changes thereto may be made based on the municipality. FIG. 1 merely provides a representation suitable for demonstrating the use of the THM treatment composition to supply potable water having levels of THM safe for the end user. In the method for reducing trihalomethane in the supplied water from water system 10, the composition of the present invention may be injected at any one of plurality of locations 52 within the water treatment portion of water treatment system or at injection points 62 located within supply lines 28. Additionally, more than one injection point may be desired to ensure that water supplied to customers 30 continues to contain less than the maximum permitted levels of trihalomethane.

In the method of reducing trihalomethane, the THM treatment composition is injected through at least one injection point 52 and optionally through a plurality of injection points 52, 62) into the water treatment system 10. Suitable injection points 52 include: prior to sedimentation tank 20, prior to filtration system 22, prior to disinfection system 24, prior to storage reservoir 26 and into storage reservoir 26. Additional injection points 62 as well as other similar injection points may be located throughout the supply lines 28, as well as any additional storage tanks (not shown) located within the distribution system or additional disinfectant booster stations (not shown). The inclusion of injection points 52, 62 will be based on testing of water supplied to municipal customers and located to counter-act any supplemental injections of chlorine or other disinfecting agents which may produce THM. Thus, injection points 52 and 62 will vary from water system to water system with the selection of locations based on testing of the system to determine locations requiring treatment with the THM treatment composition in order to maintain THM at acceptable levels.

To maintain THM levels below the EPA mandated levels, the present invention will generally provide for regular injections of the aqueous THM treatment composition. Typically, the aqueous THM treatment composition will be stored in a suitable tank (not shown) and injected under pressure using a pump (not shown). Depending on the configuration of the water treatment system and location of injection points 52, 62, a single tank/pump arrangement may supply the THM treatment composition to the system or separate tanks and pumps will provide the THM treatment composition to the injection points. Typically, injection points 62, downstream of the water treatment facility, will require a separate source of THM treatment composition from the source used to supply water treatment system 10.

The volume of aqueous THM treatment composition injected will be determined by frequent testing of water at a variety of locations within water treatment system 10 and customer supply lines 28. In general, the THM treatment solution will be injected by a pump from a storage container, such as, but not limited to, a drum, tank or other similar vessel. Utilizing the known or predicted concentration of THM within the water, a desired volume of THM treatment composition will be injected to ensure reduction and/or maintenance of THM levels below the minimum safe level. Such injections may be into either storage tanks, such as tank 26, or pressurized water lines such as supply lines 28. Under most circumstances, about 0.05 to about 0.1 milliliters of aqueous THM treatment composition will be injected per liter of treated water. The injections occur under ambient conditions of temperature and pressure and do not require heating of the THM treatment composition. The pumps used for injection of the THM treatment composition will be the same type commonly used for injection of other water treatment chemicals, such as coagulants or corrosion inhibitors. These pumps, well known to those skilled in the art of water treatment, allow for supplying a pre-determined amount of treatment chemical at a constant rate. When injecting water treatment compounds, the feed rate depends on the flow rate of the water and the feed rate is calculated to result in the desired final concentration of the treatment chemical in the water. The feed rate can be set manually at the injection pump or automatically though a feed-back system in which the injection rate is coupled to a flow meter in the water line.

To demonstrate the effectiveness of the present invention at lowering THM concentrations within water, a series of tests were conduct using a variety of the optional formulations for the aqueous THM treatment composition. Table 1 identifies each formulation of the aqueous THM treatment composition tested with results for solutions 1-17 reported in Table 2. In Table 1, the percent by weight column reflects the final percent by weight of each component as calculated using their concentrations in the respective stock solutions. Thus, the final percent by weight reflects that actual concentration of acid not the concentration of acid feed stock.

The tests reported in Table 2 used filtered water from a municipal water treatment system containing THM in the concentrations reported for each indicated control sample. Column 2 (ppm THM Treatment Composition) of Table 2 indicates the final concentration of THM treatment composition in the treated water prior to reaction with THM. In each instance, even the lower concentration of the aqueous THM treatment composition reduced the THM concentration below 80 ppb while the higher concentrations of the aqueous THM treatment composition reduced the levels of THM to below the detection limits of the instrumentation.

Thus, Table 2 demonstrates the effectiveness of the THM treatment composition in reducing THM levels to less than the required minimums set by government entities. As reported in Table 2, tests were performed over three days. Each set of tests utilized a separate control sample to calibrate the analytical equipment and representative of the ppb THM in the respective test samples for that day. As reported in Table 2 Control A and the samples treated on Dec. 17, 2012 contained 56 ppb THM, Control B and the samples treated on Dec. 20, 2012 contained 53 ppb THM, and Control C and the samples treated on Dec. 21, 2012 contained 72 ppb THM.

For each test, the identified solution of THM treatment composition was added to the filtered water in a volume sufficient to provide the concentrations specified in the “ppm THM Treatment Composition” column. Over the course of the three days, at least two different concentrations for each solution were tested. Following addition of the THM treatment composition, the resulting solution was allowed to react for one hour followed by analysis using the HACH THM Plus assay to determine the final THM concentration. The reaction period occurred at ambient conditions and did not require constant stirring after the initial injection. The results in parts per billion THM are given in the “ppb THM following treatment” column. Since the reaction between the THM treatment composition and the THM within the samples does not require stirring, when used within a water municipality treatment system, simple injection of the THM treatment composition will be sufficient to achieve reduction in THM within the water supply.

The HACH THM Plus testing system is an industry accepted system and method for determining THM levels in water. However, any suitable quantitative testing capable of determining THM concentrations could have been used in these tests. The lower limit of the THM Plus assay is 10 ppb. Thus, results below the limit of detection of the test are given as <10. The results in the “% Reduction” were determined by comparing the final THM concentration for each solution to the respective control value for the set.

TABLE 1

| | Stock % | Stock ml/L | Final wt % |
|---|---|---|---|
| Solution 1 | | | |
| Phosphoric Acid | 85 | 230.0 | 29.00 |
| Dipropylene Glycol | 100 | 0.1 | 0.01 |
| Monomethyl Ether | | | |
| Triethanolamine | 85 | 6.0 | 0.48 |
| Solution 2 | | | |
| Hydrochloric Acid | 33 | 230.0 | 8.10 |
| Dipropylene Glycol | 100 | 0.1 | 0.01 |
| Monomethyl Ether | | | |
| Triethanolamine | 85 | 6.0 | 0.48 |
| Solution 3 | | | |
| Nitric Acid | 70 | 230.0 | 20.70 |
| Dipropylene Glycol | 100 | 0.1 | 0.01 |
| Monomethyl Ether | | | |
| Triethanolamine | 85 | 6.0 | 0.48 |
| Solution 4 | | | |
| Phosphoric Acid | 85 | 230.0 | 29.00 |
| Dipropylene Glycol | 100 | 0.1 | 0.01 |
| Monomethyl Ether | | | |
| Diethanolamine | 85 | 6.0 | 0.48 |
| Solution 5 | | | |
| Phosphoric Acid | 85 | 230.0 | 29.00 |
| Dipropylene Glycol | 100 | 0.1 | 0.01 |
| Diethanolamine | 85 | 6.0 | 0.48 |
| Solution 6 | | | |
| Phosphoric Acid | 85 | 230.0 | 29 |
| Propylene Glycol | 100 | 0.1 | 0.01 |
| Monomethyl Ether | | | |
| Triethanolamine | 85 | 6.0 | 0.48 |
| Solution 7 | | | |
| Phosphoric Acid | 85 | 230.0 | 29.00 |
| Propylene Glycol | 100 | 0.1 | 0.01 |
| Monomethyl Ether | | | |
| Diethanolamine | 85 | 6.0 | 0.48 |
| Solution 8 | | | |
| Phosphoric Acid | 85 | 230.0 | 29.00 |
| Ethylene Glycol | 100 | 0.1 | 0.01 |
| Monobutyl Ether | | | |
| Triethanolamine | 85 | 6.0 | 0.48 |
| Solution 9 | | | |
| Phosphoric Acid | 85 | 230.0 | 29.00 |
| Ethylene Glycol | 100 | 0.1 | 0.01 |
| Monobutyl Ether | | | |
| Diethanolamine | 85 | 6.0 | 0.48 |
| Solution 10 | | | |
| Phosphoric Acid | 85 | 230.0 | 29.00 |
| Propylene Glycol | 100 | 0.1 | 0.01 |
| Monobutyl Ether | | | |
| Triethanolamine | 85 | 6.0 | 0.48 |
| Solution 11 | | | |
| Phosphoric Acid | 85 | 230.0 | 29.00 |
| Propylene Glycol | 100 | 0.1 | 0.01 |
| Monobutyl Ether | | | |
| Diethanolamine | 85 | 6.0 | 0.48 |
| Solution 12 | | | |
| Phosphoric Acid | 85 | 230.0 | 29.00 |
| Diethylene Glycol | 100 | 0.1 | 0.01 |
| Monopropyl Ether | | | |
| Triethanolamine | 85 | 6.0 | 0.48 |
| Solution 13 | | | |
| Phosphoric Acid | 85 | 230.0 | 29.00 |
| Diethylene Glycol | 100 | 0.1 | 0.01 |
| Monopropyl Ether | | | |
| Diethanolamine | 85 | 6.0 | 0.48 |
| Solution 14 | | | |
| Phosphoric Acid | 85 | 230.0 | 29.00 |
| Diethylene Glycol Ethyl | 100 | 0.1 | 0.01 |
| Ether | | | |
| Triethanolamine | 85 | 6.0 | 0.48 |
| Solution 15 | | | |
| Phosphoric Acid | 85 | 230.0 | 29.00 |
| Diethylene Glycol Ethyl | 100 | 0.1 | 0.01 |
| Ether | | | |
| Diethanolamine | 85 | 6.0 | 0.48 |
| Solution 16 | | | |
| Phosphoric Acid | 85 | 230.0 | 29.00 |
| Propylene Glycol Tributyl | 100 | 0.1 | 0.01 |
| Ether | | | |
| Triethanolamine | 85 | 6.0 | 0.48 |
| Solution 17 | | | |
| Phosphoric Acid | 85 | 230.0 | 29.00 |
| Propylene Glycol Tributyl | 100 | 0.1 | 0.01 |
| Ether | | | |
| Diethanolamine | 85 | 6.0 | 0.48 |
| Solution 18 | | | |
| Phosphoric Acid | 85 | 230 | 29.00 |
| Dipropylene Glycol | | 0.2 | 0.02 |
| Monomethyl Ether | | | |
| Triethanolamine | 85 | 6.0 | 0.48 |
| Solution 19 | | | |
| Phosphoric Acid | 85 | 235.0 | 29.50 |
| Dipropylene Glycol | 100 | 0.05 | 0.004 |
| Monomethyl Ether | | | |
| Triethanolamine | 85 | 0.03 | 0.002 |
| Solution 20 | | | |
| Phosphoric Acid | 85 | 190.0 | 24.00 |
| Dipropylene Glycol | 100 | 250.0 | 21.00 |
| Monomethyl Ether | | | |
| Triethanolamine | 85 | 100.0 | 8.60 |
| Solution 21 | | | |
| Phosphoric Acid | 85 | 375.0 | 42.00 |
| Dipropylene Glycol | 100 | 100.0 | 7.60 |
| Monomethyl Ether | | | |
| Triethanolamine | 85 | 100.0 | 7.70 |
| Solution 22 | | | |
| Phosphoric Acid | 85 | 195.0 | 24.50 |
| Dipropylene Glycol | 100 | 46.0 | 3.92 |
| Monomethyl Ether | | | |
| Triethanolamine | 85 | 46.0 | 3.94 |

TABLE 2

| | | ppm THM | ppb THM | |
|---|---|---|---|---|
| | | Treatment | following | |
| Solution | Date | Composition | treatment | % Reduction |
| Control A - | Dec. 17, 2012 | | | |
| 56 ppb THM | | | | |
| 1 | Dec. 17, 2012 | 10 | 19 | 66 |
| 1 | Dec. 17, 2012 | 300 | <10 | >82 |
| 2 | Dec. 17, 2012 | 10 | 28 | 50 |
| 2 | Dec. 17, 2012 | 300 | <10 | >82 |
| 3 | Dec. 17, 2012 | 10 | 52 | 7 |
| 3 | Dec. 17, 2012 | 300 | <10 | >82 |
| 4 | Dec. 17, 2012 | 10 | 33 | 41 |
| 4 | Dec. 17, 2012 | 300 | <10 | >82 |
| 5 | Dec. 17, 2012 | 10 | 53 | 5 |
| 5 | Dec. 17, 2012 | 300 | <10 | >82 |
| Control B - | Dec. 20, 2012 | | | |
| 53 ppb THM | | | | |
| 6 | Dec. 20, 2012 | 20 | 53 | 0 |
| 6 | Dec. 20, 2012 | 200 | <10 | >81 |
| 7 | Dec. 20, 2012 | 20 | 39 | 26 |
| 7 | Dec. 20, 2012 | 200 | <10 | >81 |
| 1 | Dec. 20, 2012 | 20 | 31 | 42 |
| 1 | Dec. 20, 2012 | 200 | <10 | >81 |
| 4 | Dec. 20, 2012 | 20 | 52 | 2 |
| 4 | Dec. 20, 2012 | 200 | <10 | >81 |
| Control C - | Dec. 21, 2012 | | | |
| 72 ppb THM | | | | |
| 8 | Dec. 21, 2012 | 20 | 54 | 25 |
| 8 | Dec. 21, 2012 | 200 | <10 | >86 |
| 9 | Dec. 21, 2012 | 20 | 50 | 31 |
| 9 | Dec. 21, 2012 | 200 | <10 | >86 |
| 10 | Dec. 21, 2012 | 20 | 59 | 18 |
| 10 | Dec. 21, 2012 | 200 | <10 | >86 |
| 11 | Dec. 21, 2012 | 20 | 60 | 17 |
| 11 | Dec. 21, 2012 | 200 | <10 | >86 |
| 12 | Dec. 21, 2012 | 20 | 60 | 17 |
| 12 | Dec. 21, 2012 | 200 | <10 | >86 |
| 13 | Dec. 21, 2012 | 20 | 67 | 7 |
| 13 | Dec. 21, 2012 | 200 | <10 | >86 |
| 14 | Dec. 21, 2012 | 20 | 55 | 24 |
| 14 | Dec. 21, 2012 | 200 | <10 | >86 |
| 15 | Dec. 21, 2012 | 20 | 36 | 50 |
| 15 | Dec. 21, 2012 | 200 | <10 | >86 |
| 16 | Dec. 21, 2012 | 20 | 53 | 26 |
| 16 | Dec. 21, 2012 | 200 | <10 | >86 |
| 17 | Dec. 21, 2012 | 20 | 46 | 36 |
| 17 | Dec. 21, 2012 | 200 | <10 | >86 |
| 1 | Dec. 21, 2012 | 20 | 54 | 25 |
| 1 | Dec. 21, 2012 | 200 | <10 | >86 |
| 1 | Dec. 21, 2012 | 20 | 49 | 32 |
| 1 | Dec. 21, 2012 | 200 | <10 | >86 |
| 7 | Dec. 21, 2012 | 20 | 46 | 36 |
| 7 | Dec. 21, 2012 | 200 | <10 | >86 |

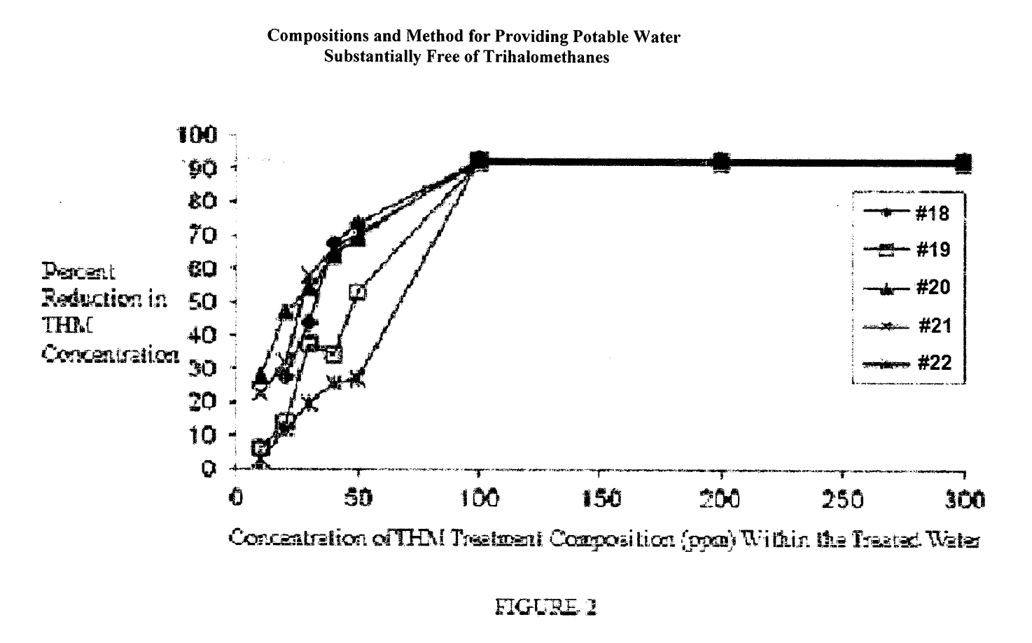

To further demonstrate the effectiveness of the aqueous THM treatment composition, five formulations of the aqueous THM treatment composition were tested at various concentrations in water containing 72 ppb THM. The aqueous THM treatment compositions identified as Solutions 18-22 in Table 1 were used in this test. Table 3 identifies the pre-treatment and post-treatment THM levels within the water sample and the final concentration of aqueous THM treatment compositions following addition to the water sample but prior to reaction with THM. Table 4 provides a comparison of the percent reduction at each concentration of THM treatment composition and FIG. 2 graphically depicts the percent reduction of THM following treatment with the aqueous THM treatment compositions at the indicated concentrations. The methods used to treat the water samples and determine ppb THM to produce the results in Tables 3 and 4 were identical to those used in the prior example.

As reflected in Table 4 and FIG. 2, treatment of water initially containing 72 ppb THM with as little as 50 ppm of Solutions 18, 20 and 21 achieved at least 69% reduction in total THM. As noted above, the ppm of THM treatment composition refers to the final concentration of THM treatment composition within the test sample prior to reaction with THM. For each Solution identified in Tables 3 and 4, treatment using 100 ppm or more of THM treatment composition produced at least 92% reduction in total THM. Further, treatment concentrations as low as 30 ppm of THM treatment composition in the contaminated water produced % reduction levels of about 40% or greater in Solutions 18-21. Thus, the THM treatment composition provides a safe effective tool for lowering trihalomethanes in water.

TABLE 3

| | ppm of | | | |
|---|---|---|---|---|
| | aqueous THM | | | |
| | treatment | Initial THM | THM Post | % |
| Solution | composition | ppb | Treatment ppb | Reduction |
| Solution 18 | 300 | 68 | 5 | 93 |
| Solution 18 | 200 | 68 | 5 | 93 |
| Solution 18 | 100 | 68 | 5 | 93 |
| Solution 18 | 50 | 68 | 18 | 74 |
| Solution 18 | 40 | 68 | 22 | 68 |
| Solution 18 | 30 | 68 | 38 | 44 |
| Solution 18 | 20 | 68 | 49 | 28 |
| Solution 19 | 300 | 64 | 5 | 92 |
| Solution 19 | 200 | 64 | 5 | 92 |
| Solution 19 | 100 | 64 | 5 | 92 |
| Solution 19 | 50 | 64 | 30 | 53 |
| Solution 19 | 40 | 64 | 42 | 34 |
| Solution 19 | 30 | 64 | 40 | 38 |
| Solution 19 | 20 | 64 | 55 | 14 |
| Solution 19 | 10 | 64 | 60 | 6 |
| Solution 20 | 300 | 72 | 5 | 93 |
| Solution 20 | 200 | 72 | 5 | 93 |
| Solution 20 | 100 | 72 | 5 | 93 |
| Solution 20 | 50 | 72 | 22 | 69 |
| Solution 20 | 40 | 72 | 26 | 64 |
| Solution 20 | 30 | 72 | 33 | 54 |
| Solution 20 | 20 | 72 | 38 | 47 |
| Solution 20 | 10 | 72 | 52 | 28 |
| Solution 21 | 300 | 62 | 5 | 92 |
| Solution 21 | 200 | 62 | 5 | 92 |
| Solution 21 | 100 | 62 | 5 | 92 |
| Solution 21 | 50 | 62 | 18 | 71 |
| Solution 21 | 40 | 62 | 21 | 66 |
| Solution 21 | 30 | 62 | 26 | 58 |
| Solution 21 | 20 | 62 | 42 | 32 |
| Solution 21 | 10 | 62 | 48 | 23 |
| Solution 22 | 300 | 66 | 5 | 92 |
| Solution 22 | 200 | 66 | 5 | 92 |
| Solution 22 | 100 | 66 | 5 | 92 |
| Solution 22 | 50 | 66 | 48 | 27 |
| Solution 22 | 40 | 66 | 49 | 26 |
| Solution 22 | 30 | 66 | 53 | 20 |
| Solution 22 | 20 | 66 | 58 | 12 |
| Solution 22 | 10 | 66 | 64 | 3 |

TABLE 4

| | Solution | Solution | Solution | Solution | Solution |
|---|---|---|---|---|---|
| | #18 | #19 | #20 | #21 | #22 |
| ppm THM | Percent | Percent | Percent | Percent | Percent |
| Treatment | Reduction | Reduction | Reduction | Reduction | Reduction |
| Composition | in THM | in THM | in THM | in THM | in THM |
| 300 | 93 | 92 | 93 | 92 | 92 |
| 200 | 93 | 92 | 93 | 92 | 92 |
| 100 | 93 | 92 | 93 | 92 | 92 |
| 50 | 74 | 53 | 69 | 71 | 27 |
| 40 | 68 | 34 | 64 | 66 | 26 |
| 30 | 44 | 38 | 54 | 58 | 20 |
| 20 | 28 | 14 | 47 | 32 | 12 |
| 10 | | 6 | 28 | 23 | 3 |

Other embodiments of the present invention will be apparent to one skilled in the art. As such, the foregoing description merely enables and describes the general uses and methods of the present invention. Accordingly, the following claims define the true scope of the present invention.

What is claimed is:

1. A composition comprising:
a mineral acid;
a glycol ether;
an alkanolamine; and,
water.

2. A composition comprising:
a mineral acid selected from the group consisting of phosphoric acid, hydrochloric acid, nitric acid and sulfuric acid and mixtures thereof;
an alkanolamine selected from the group consisting of ethanolamine, diethanolamine, triethanolamine and mixtures thereof;
a glycol ether selected from the group consisting of propylene glycol mono-methyl ether, dipropylene glycol methyl ether, dipropylene glycol, ethylene glycol monobutyl ether, diethylene glycol monopropyl ether, propylene glycol t-butyl ether, diethylene glycol ethyl ether and mixtures thereof; and, water.

3. The composition of claims 1 or 2, wherein said mineral acid comprises from about 5% to about 50% by weight of the composition.

4. The composition of claims 1 or 2, wherein said glycol ether comprises from about 0.004% to about 25% by weight of the composition.

5. The composition of claim 1 or 2, wherein said alkanolamine comprises from about 0.003% to about 10% by weight of the composition.

6. The composition of claims 1 or 2, wherein said mineral acid comprises from about 20% to about 45% by weight of the composition.

7. The composition of claims 1 or 2, wherein said glycol ether comprises from about 0.005% to about 21% by weight of the composition.

8. The composition of claim 1 or 2, wherein said alkanolamine comprises from about 0.005% to about 10% by weight of the composition.

9. The composition of claims 1 or 2, wherein said mineral acid comprises from about 20% to about 30% by weight of the composition.

10. The composition of claims 1 or 2, wherein said glycol ether comprises from about 0.005% to about 0.05% by weight of the composition.

11. The composition of claim 1 or 2, wherein said alkanolamine comprises from about 0.1% to about 1% by weight of the composition.

12. The composition of claims 1 or 2, wherein:
said mineral acid comprises from about 10% to about 50% by weight of the composition;
said glycol ether comprises from about 0.005% to about 25% by weight of the composition; and,
said alkanolamine comprises from about 0.003% to about 10% by weight of the composition.

13. The composition of claims 1 or 2, wherein:
said mineral acid comprises from about 20% to about 45% by weight of the composition;
said glycol ether comprises from about 0.005% to about 21% by weight of the composition; and,
said alkanolamine comprises from about 0.005% to about 10% by weight of the composition.

14. The composition of claims 1 or 2, wherein:
said mineral acid comprises from about 20% to about 30% by weight of the composition;
said glycol ether comprises from about 0.005% to about 0.05% by weight of the composition; and,
said alkanolamine comprises from about 0.1% to about 1% by weight of the composition.

15. A method for preparing a trihalomethane reducing composition comprising the steps of:
initially preparing a solution of mineral acid in water wherein the mineral acid comprises from about 20% to about 60% by weight of the aqueous solution;
adding an alkanolamine the aqueous acid solution; and,
adding a glycol ether to said aqueous solution.

16. A method for preparing a trihalomethane reducing composition comprising the steps of:
initially preparing a solution of mineral acid in water wherein the mineral acid comprises from about 20% to about 40% by weight of the aqueous solution;
adding an alkanolamine the aqueous acid solution;
adding a glycol ether to said aqueous solution;
wherein said mineral acid comprises from about 10% to about 30% by weight of the final solution;
wherein said alkanolamine comprises from about 0.003% to about 10% of the final solution; and,
wherein said glycol ether comprises from about 0.005% to about 25% of the final solution.

17. The method of claims 15 or 16 wherein the mixing time of the initial acid solution is from about 5 minutes to about 60 minutes.

18. The method of claims 15 or 16 wherein the mixing time of the initial acid solution is from about 10 minutes to about 50 minutes.

19. The method of claims 15 or 16 wherein the mixing time of the initial acid solution is from about 15 minutes to about 45 minutes.

20. The method of claims 15 or 16 wherein the mixing time of the initial acid solution is from about 20 minutes to about 40 minutes.

21. The method of claims 15 or 16 wherein the step of blending the alkanolamine into the aqueous acid solution is from about 5 minutes to about 60 minutes.

22. The method of claims 15 or 16 wherein the step of blending the alkanolamine into the aqueous acid solution is from about 10 minutes to about 50 minutes.

23. The method of claims 15 or 16 wherein the step of blending the alkanolamine into the aqueous acid solution is from about 15 minutes to about 45 minutes.

24. The method of claims 15 or 16 wherein the step of blending the alkanolamine into the aqueous acid solution is from about 15 minutes to about 35 minutes.

25. The method of claims 15 or 16 wherein the step of blending the glycol ether into the aqueous solution of mineral acid and alkanolamine is from about 5 minutes to about 90 minutes.

26. The method of claims 15 or 16 wherein the step of blending the glycol ether into the aqueous solution of mineral acid and alkanolamine is from about 10 minutes to about 80 minutes.

27. The method of claims 15 or 16 wherein the step of blending the glycol ether into the aqueous solution of mineral acid and alkanolamine is from about 15 minutes to about 75 minutes.

28. The method of claims 15 or 16 wherein the step of blending the glycol ether into the aqueous solution of mineral acid and alkanolamine is from about 20 minutes to about 70 minutes.

29. The method of claims 15 or 16 wherein the step of blending the glycol ether into the aqueous solution of mineral acid and alkanolamine is from about 25 minutes to about 70 minutes.

30. The method of claims 15 or 16 wherein the step of blending the glycol ether into the aqueous solution of mineral acid and alkanolamine is from about 30 minutes to about 70 minutes.

31. The method of claims 15 or 16 wherein the step of blending the glycol ether into the aqueous solution of mineral acid and alkanolamine is from about 35 minutes to about 60 minutes.

32. The method of claims 15 or 16 wherein the mineral acid is selected from the group consisting of phosphoric acid, hydrochloric acid, nitric acid and sulfuric acid and mixtures thereof.

33. The method of claims 15 or 16 wherein the an alkanolamine is selected from the group consisting of ethanolamine, diethanolamine, triethanolamine and mixtures thereof

34. The method of claims 15 or 16 wherein the glycol ether is selected from the group consisting of propylene glycol mono-methyl ether, dipropylene glycol methyl ether, dipropylene glycol, ethylene glycol monobutyl ether, diethylene glycol monopropyl ether, propylene glycol t-butyl ether, diethylene glycol ethyl ether, ethylene glycol monomethyl ether, ethylene glycol monoethyl ether, ethylene glycol monopropyl ether, ethylene glycol monoisopropyl ether, diethylene glycol monomethyl ether, ethylene glycol dimethyl ether, ethylene glycol diethyl ether, ethylene glycol dibutyl ether ethylene glycol methyl ether acetate, ethylene glycol monethyl ether acetate, ethylene glycol monobutyl ether acetate and mixtures thereof.

35. The method of claim 16, wherein:
said mineral acid comprises from about 5% to about 50% by weight of the final solution;
said glycol ether comprises from about 0.005% to about 25% by weight of the final solution; and,
said alkanolamine comprises from about 0.003% to about 10% by weight of the final solution.

36. The composition of claim 16, wherein:
said mineral acid comprises from about 20% to about 45% by weight of the final solution;
said glycol ether comprises from about 0.005% to about 21% by weight of the final solution; and,
said alkanolamine comprises from about 0.005% to about 10% by weight of the final solution.

37. The composition of claim 16, wherein:
said mineral acid comprises from about 5% to about 45% by weight of the final solution;
said glycol ether comprises from about 0.005% to about 25% by weight of the final solution; and,
said alkanolamine comprises from about 0.003% to about 10% by weight of the final solution.

38. A method for reducing tri-halo methane concentration in drinking water, the method comprising the steps:
preparing an aqueous solution comprising a mineral acid, a glycol ether and a surfactant;
adding said aqueous solution to a supply of drinking water containing trihalomethanes or trihalomethane precursors;
wherein the addition of said aqueous solution yields a concentration of about 5 ppm to about 500 ppm of said aqueous solution within said drinking water prior to reduction of said trihalomethanes concentration within said drinking water and wherein the concentration of trihalomethane is reduced by about 20% to about 80% from the concentration within the water without treatment with said aqueous solution.

39. The method of claim 38, wherein said aqueous solution comprises a mineral acid selected from the group consisting of phosphoric acid, hydrochloric acid, nitric acid and sulfuric acid and mixtures thereof; a glycol ether selected from the group consisting of propylene glycol mono-methyl ether, dipropylene glycol methyl ether, dipropylene glycol, ethylene glycol monobutyl ether, diethylene glycol monopropyl ether, propylene glycol t-butyl ether, diethylene glycol ethyl ether and mixtures thereof; an alkanolamine selected from the group consisting of ethanolamine, diethanolamine, triethanolamine and mixtures thereof; and, water.

40. The method of claim 38, wherein the aqueous solution is continuously injected at a rate sufficient to yield a concentration of about 5 ppm to about 300 ppm of said aqueous solution within said drinking water.

41. The method of any of claims 38, 39 or 40 further comprising the step of injecting said aqueous solution into a water supply system at an injection point selected from the group consisting of: prior to a coagulation or flocculation step; after a coagulation or flocculation step; following a filtration of solids step; following the addition of chlorine to said water supply.
